(19) United States
(12) Patent Application Publication
(10) Pub. No.: US 2017/0025013 A1
(43) Pub. Date: Jan. 26, 2017

(54) DISTANCE CALCULATION APPARATUS, DISTANCE CALCULATION METHOD, DRIVING ASSIST APPARATUS, AND DRIVING ASSIST SYSTEM

(71) Applicant: MANDO CORPORATION, Pyeongtaek-si (KR)

(72) Inventor: Junhee LEE, Suwon-si (KR)

(21) Appl. No.: 15/203,760

(22) Filed: Jul. 6, 2016

(30) Foreign Application Priority Data
Jul. 7, 2015 (KR) 10-2015-0096234

(51) Int. Cl. G08G 1/16; G06T 7/00; G06T 7/60; G06K 9/00; G06K 9/32

(52) U.S. Cl. CPC G08G 1/163; G06K 9/00798; G06K 9/00825; G06K 9/3241; G08G 1/166; G06T 7/60; G06T 7/0051; G06T 2207/10016; G06T 2207/10028; G06T 2207/30256; G06T 2207/30236

(57) ABSTRACT

Disclosed herein are a distance calculation apparatus, which includes a reception unit configured to communicate with at least one object of another vehicle and infrastructure so as to receive object information including one or more of length information of the object and state information of the object, a detection unit configured to detect a first length, as a length of the object, on a focal plane of a camera capturing the object, and a calculation unit configured to calculate a second length as a length of the object relative to a focal plane axis, based on the length information and state information of the object, and to calculate a distance from the object, based on a focal plane distance, as a distance between a focus and the focal plane of the camera, and the first and second lengths, and a driving assist apparatus using the same.

### CROSS-REFERENCE(S) TO RELATED APPLICATIONS

This application claims priority to Korean Patent Application No(s). 10-2015-0096234, filed on Jul. 7, 2015 the disclosure of which is incorporated herein by reference in its entirety.

### BACKGROUND OF THE INVENTION

Field of the Invention

Exemplary embodiments of the present invention relate to a distance calculation apparatus, and a driving assist apparatus and system using the same.

Description of the Related Art

In general, vehicles travel at high or low speed, or move for parking under various external environments, and drivers may therefore drive safely without any accident by controlling the vehicles so as to actively cope with the various external environments.

However, if the safety driving of vehicles entirely depends on the driving skill and ability to handle situation of each individual driver, poor drivers may have limited access to the vehicles which are necessaries of life.

Therefore, in order to secure safety driving without the active handling of drivers, a variety of vehicle control techniques have been applied to vehicles based on the developed techniques of electronic and control. As a result, poor drivers can have high access to the vehicles, and particularly, good drivers can also have improved convenience of control.

The vehicles, to which the various vehicle control techniques are applied, are typically referred to as “smart vehicles”.

The vehicle control techniques applied to the smart vehicles may include, for example, an ASCC (Advanced Smart Cruise Control), an AEBS (Auto Emergence Braking System), an SPAS (Smart Parking Assist System), and a PAS (Parking Assist

System).

The ASCC functions to secure safety by allowing a vehicle to cruise at constant speed and maintaining the distance between the vehicle and a leading vehicle, without the operation of a pedal by a driver when the vehicle travels.

The AEBS functions to safely secure the distance between a vehicle and a leading vehicle without the operation of a driver when the vehicle travels.

The SPAS functions for convenient backward parking without changing a shift lever when a vehicle is parked, and the PAS functions for rapid backward parking even when obstacles emerge suddenly.

However, in order to actually apply smart functions, such as in the ASCC, the AEBS, the SPAS, and the PAS, to the vehicle, they must be specialized such that an accurate distance is measured when the vehicle is driven.

Accordingly, the typical vehicle uses a camera and radar together to accurately measure a distance, but this causes increases in cost and volume.

### SUMMARY OF THE INVENTION

An object of the present invention is to provide a distance calculation apparatus capable of accurately measuring a distance using only a camera.

Another object of the present invention is to provide a driving assist apparatus and system operated based on the distance accurately measured using only a camera.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with a first aspect of the present invention, a distance calculation apparatus includes a reception unit configured to communicate with at least one object of another vehicle and infrastructure so as to receive object information including one or more of length information of the object and state information of the object, a detection unit configured to detect a first length, as a length of the object, on a focal plane of a camera capturing the object, and a calculation unit configured to calculate a second length as a length of the object relative to a focal plane axis, based on the length information and state information of the object, and to calculate a distance from the object, based on a focal plane distance, as a distance between a focus and the focal plane of the camera, and the first and second lengths.

In accordance with a second aspect of the present invention, a driving assist apparatus includes a reception unit configured to communicate with at least one object of another vehicle and infrastructure so as to receive object information including one or more of length information of the object and state information of the object, a detection unit configured to detect a first length, as a length of the object, on a focal plane of a camera capturing the object, a calculation unit configured to calculate a second length as a length of the object relative to a focal plane axis, based on the length information and state information of the object, and to calculate a distance from the object, based on a focal plane distance, as a distance between a focus and the focal plane of the camera, and the first and second lengths, and one or more of an alarm provision device to provide an alarm based on the distance from the object, a speed controller to control a speed based on the distance from the object, and a steering controller to control a steering system based on the distance from the object.

In accordance with a third aspect of the present invention, a driving assist system includes a reception unit configured to communicate with at least one object of another vehicle and infrastructure so as to receive object information including one or more of length information of the object, state information of the object, and GPS position information of the object by wireless vehicle communication (V2X), an image processing unit configured to perform one or more of first image processing for sensing only an ROI set based on the GPS position information and second image processing for analyzing an edge of an image of the object captured by a camera to correct the image, so as to detect a first length, as a length of the object, on a focal plane of the camera, based on the obtained image, a storage unit configured to store one or more, of the object information and a focal plane distance as a distance between a focus and the focal plane of the camera, as data, a calculation unit configured to calculate a second length as a length of the object relative to a focal plane axis, based on the length information and state information of the object, to calculate a distance from the object based on the focal plane distance and the first and second lengths, and to calculate a TTC based on the distance from the object, and a transmission unit configured to transmit one or more of the distance from the object and the TTC to the other vehicle by wireless vehicle communication.

In accordance with a fourth aspect of the present invention, a distance calculation method includes performing a reception process of communicating with at least one object of another vehicle and infrastructure so as to receive object information including one or more of length information of the object and state information of the object, performing a detection process of detecting a first length, as a length of the object, on a focal plane of a camera capturing the object, and performing a calculation process of calculating a second length as a length of the object relative to a focal plane axis, based on the length information and state information of the object, and of calculating a distance from the object, based on a focal plane distance, as a distance between a focus and the focal plane of the camera, and the first and second lengths.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating the configuration of a distance calculation apparatus according to an embodiment of the present invention;

FIG. 2 is a view for explaining the operation of the distance calculation apparatus according to the embodiment of the present invention;

FIG. 3A is one view for explaining the operation of the distance calculation apparatus according to the embodiment of the present invention;

FIG. 3B is another view for explaining the operation of the distance calculation apparatus according to the embodiment of the present invention;

FIG. 4 is a flowchart illustrating the operation of the distance calculation apparatus according to the embodiment of the present invention;

FIG. 5 is a diagram illustrating the configuration of a driving assist apparatus according to an embodiment of the present invention;

FIG. 6 is a diagram illustrating the configuration of a driving assist apparatus according to another embodiment of the present invention;

FIG. 7 is a diagram illustrating the configuration of a driving assist system according to an embodiment of the present invention; and

FIG. 8 is a flowchart illustrating a distance calculation method according to an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Throughout the disclosure, like reference numerals refer to like parts throughout the various figures and embodiments of the present invention. In addition, detailed descriptions of functions and constructions well known in the art may be omitted to avoid unnecessarily obscuring the gist of the present invention.

It will be understood that, although the terms first, second, A, B, (a), (b), etc. may be used herein to describe various elements, these elements should not be limited by these terms. These terms are only used to distinguish one element from another. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

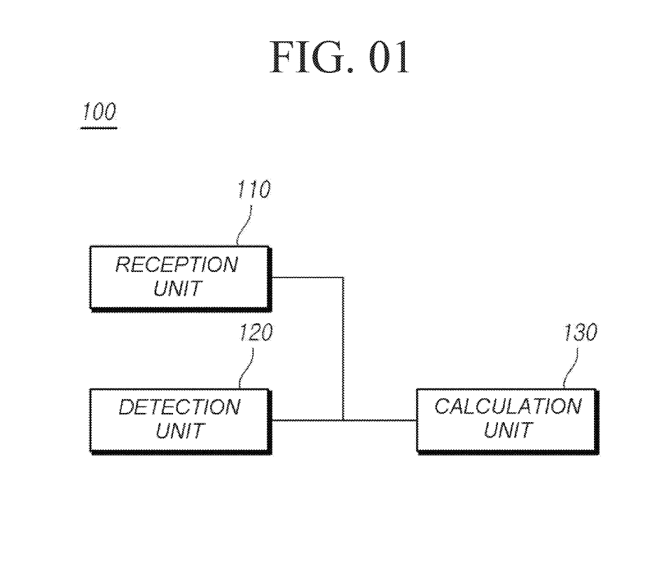

FIG. 1 is a diagram illustrating the configuration of a distance calculation apparatus according to an embodiment of the present invention.

Referring to FIG. 1, the distance calculation apparatus, which is designated by reference numeral 100, according to the embodiment of the present invention may include a reception unit 110 which communicates with at least one object of another vehicle and infrastructure to receive object information including one or more of length information of the object and state information of the object, a detection unit 120 which detects a first length, as the length of the object, on the focal plane of a camera capturing the object, and a calculation unit 130 which calculates a second length as the length of the object relative to a focal plane axis, based on the length information and state information of the object, and calculates a distance from the object, based on a focal plane distance as the distance between the focus and focal plane of the camera, and the first and second lengths.

The reception unit 110 may receive the length information and state information of the object which are transmitted using various communications such as DSRC (Dedicated Short Range Communication) and ADSRC (Advanced DSRC) as dedicated short-range ITSs (Intelligent Transport Systems), and WiBro (Wireless Broadband Internet).

Each of the DSRC and the ADSRC is a near-field communication technique between road-side equipment and OBE (On-Board Equipment), and the communication may be performed using the OBE. The WiBro is a wireless communication technique which enables massive data to be transmitted/received through internet even in a vehicle traveling at a speed of about 100 km/h, as well as internet telephone, and download and upload may be performed at speeds of respective 240 Mbps and 6 Mbps.

For example, another vehicle may transmit vehicle information about the width and heading angle thereof using the above communication techniques, and the reception unit 110 may be received the vehicle information. The heading angle means a direction of progress of a vehicle. When the heading angle of a vehicle is equal to the heading angle of another vehicle, the camera of the vehicle may detect a width corresponding to the transmitted width of the other vehicle. However, when the heading angle of the vehicle is unequal to the heading angle of the other vehicle, the camera of the vehicle detects a width smaller than the transmitted width of the other vehicle.

For another example, infrastructure (infra) installed near the road may transmit infrastructure information about the width and arrangement angle thereof using the above communication techniques, and the reception unit 110 may be received the infrastructure information. The arrangement angle may mean the arrangement of infrastructure. When the heading angle of a vehicle is equal to the arrangement angle of the infrastructure, the camera of the vehicle may detect a width corresponding to the transmitted width of the infrastructure. However, when the heading angle of the vehicle is unequal to the arrangement angle of the infrastructure, the camera of the vehicle detects a width smaller than the transmitted width of the infrastructure.

The detection unit 120 may detect the first length, as the length of the object, on the focal plane of the lens of the camera which captures the object. For example, when the camera is a CMOS camera, the focal plane may be a CMOS plane.

The calculation unit 130 may apply a difference value between the heading angle of the vehicle and the heading angle of the other vehicle to the width of the other vehicle so as to calculate a second length as the width of the other vehicle relative to the focal plane axis. The focal plane axis may mean an axis parallel with the focal plane.

In addition, the calculation unit 130 may calculate a distance from the other vehicle using the relationship of the focal plane distance as the distance between the focus and the focal plane of the camera, the detected first length, and the calculated second length.

For example, when the lens of the camera has a refractive index of 1, the ratio between the focal plane distance and the first length coincides with the ratio between the distance from the other vehicle and the second length. Thus, the distance from the other vehicle may be calculated using the above relationship.

On the other hand, when the lens of the camera has a refractive index other than 1, the product of the refractive index of the lens and the ratio between the focal plane distance and the first length coincides with the ratio between the distance from the other vehicle and the second length. Thus, the distance from the other vehicle may be calculated using the above relationship.

As described above, the distance from the other vehicle, which is calculated by the distance calculation apparatus, may be a more accurate value than a distance detected based on the image captured by a typical camera.

Unlike the distance calculation apparatus according to the embodiment of the present invention, a reception unit of a distance calculation apparatus according to a first example of the present invention may further receive the position information of an object as object information. The position information may be a position received through a GPS (Global Positioning System).

In brief, the GPS may generate a certain signal and calculate a position, at which the certain signal is generated, using accurate times and distances when three or more satellites detect the certain signal.

A detection unit of a distance calculation apparatus according to a second example of the present invention may set an ROI (Region Of Interest) based on the position information received therein, and sense only the ROI to detect a first length, as the length of an object, on a focal plane.

Since the detection unit senses only the ROI instead of an overall region, it is possible to reduce a sensing time and the size of used data.

A detection unit of a distance calculation apparatus according to a third example of the present invention may analyze the edge of the image captured by a camera to correct the image, and detect a first length on a focal plane based on the corrected image.

Since the edge extracted from the image includes critical shape information of an object and is based in recognizing and analyzing the image, the detection unit may more accurately detect the first length on the focal plane by analyzing the edge and correcting the image.

A reception unit of a distance calculation apparatus according to a fourth example of the present invention may further receive first lane information detected from another vehicle, and a calculation unit may calculate a second length, based on the comparison value of the first lane information with second lane information captured by a camera.

When errors are included in the heading angle of a vehicle and the heading angle of another vehicle, the second length may be erroneously calculated. To prevent this, the reception unit may further receive the first lane information detected from the other vehicle, and the calculation unit may calculate the second length, based on the comparison value of the first lane information with the second lane information captured by the camera.

For example, when the comparison value of the first lane information with the second lane information is great, the second length may be calculated as a value smaller than the received width. In addition, when the comparison value of the first lane information with the second lane information is “0”, the second length may be calculated as a value equal to the received width.

Each of the distance calculation apparatuses according to the first to fourth examples of the present invention further include only one function added to the distance calculation apparatus according to the embodiment of the present invention, but the present invention is not limited thereto. For example, the distance from the object may be calculated by adding one or more functions to the distance calculation apparatus.

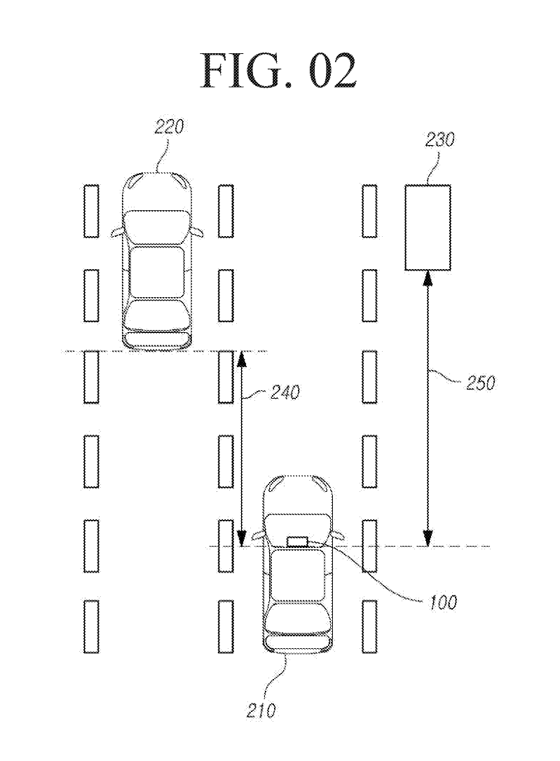

FIG. 2 is a view for explaining the operation of the distance calculation apparatus according to the embodiment of the present invention.

Referring to FIG. 2, the distance calculation apparatus 100 according to the embodiment of the present invention, which is included in a vehicle 210, may receive a width as the length information of another vehicle 220 and a heading angle as the state information thereof by communicating with the other vehicle 220 so as to calculate a distance 240 from the other vehicle 220, and may receive a width as the length information of infrastructure 230 and an installation angle as the state information thereof by communicating with the infrastructure 230 so as to calculate a distance 250 from the infrastructure 230. The installation angle may be a value corresponding to the heading angles of the vehicle 210 and the other vehicle 220. That is, when the heading angle of the other vehicle 220 and the installation angle of the infrastructure 230 are equal to the heading angle of the vehicle 210, the second length of the other vehicle 220 and the second length of the infrastructure 230, which are calculated by the calculation unit, may coincide with the received width of the other vehicle 220 and the received width of the infrastructure 230.

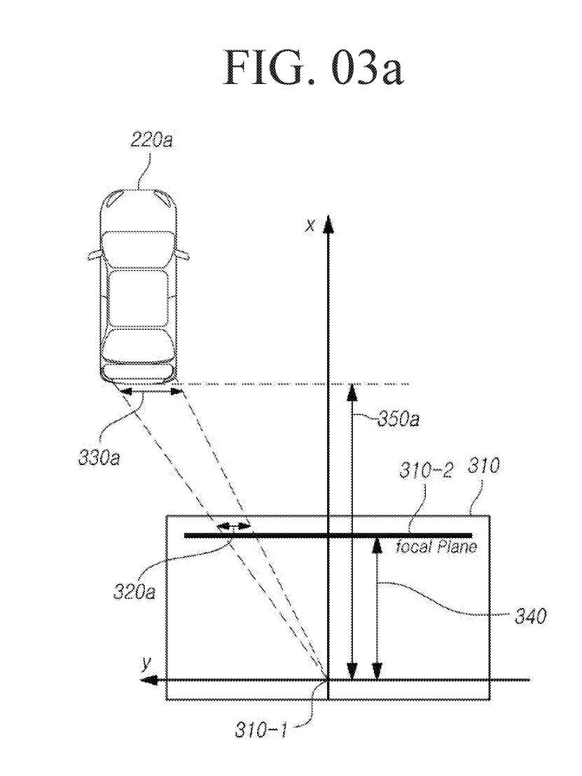

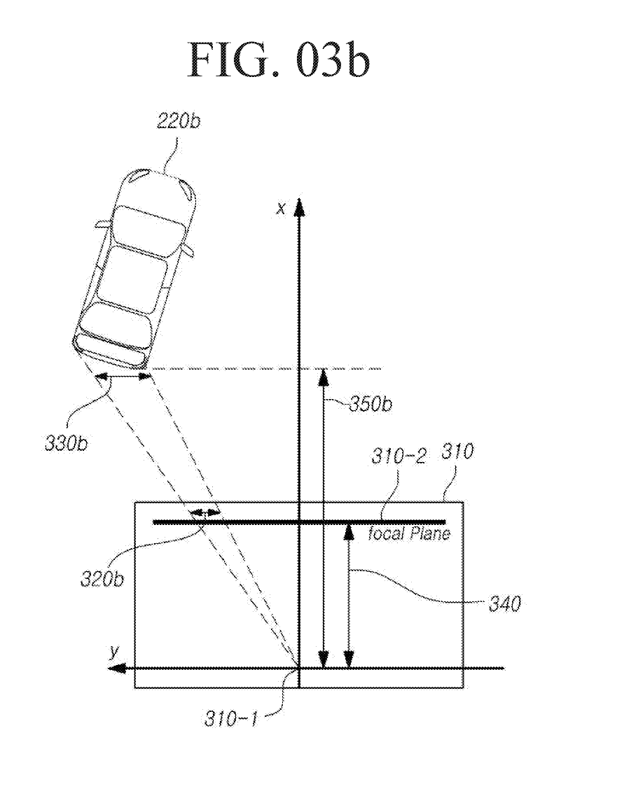

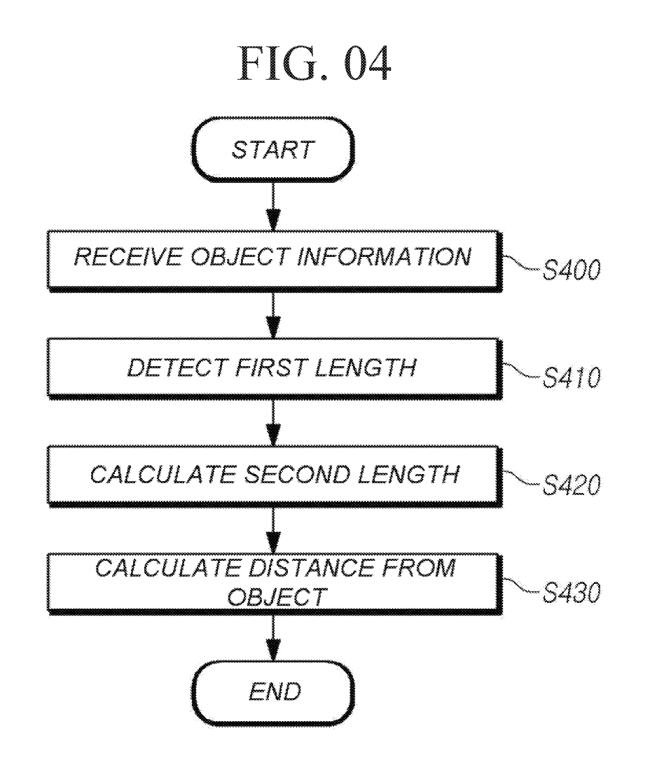

The detailed description thereof will be given with reference to FIGS. 3A to 4.

FIG. 3A is one view for explaining the operation of the distance calculation apparatus according to the embodiment of the present invention. FIG. 3B is another view for explaining the operation of the distance calculation apparatus according to the embodiment of the present invention.

Referring to FIGS. 3A and 3B, a camera 310 partially consists of a lens 310-2 and a focus 310-1. When another vehicle 220a is captured by the camera 310, the image of the other vehicle 220a may be created on the focal plane of the lens 310-2.

The detection unit of the distance calculation apparatus according to the embodiment of the present invention may detect a first length 320a of the image of the other vehicle 220a created on the focal plane.

Since the heading angle of the other vehicle 220a is equal to the heading angle of a vehicle in FIG. 3A, the calculation unit of the distance calculation apparatus according to the embodiment of the present invention may calculate a second length 330a, as the length of the other vehicle 220a relative to the focal plane axis, which is equal to the width of the other vehicle 220a.

In addition, the calculation unit of the distance calculation apparatus according to the embodiment of the present invention may calculate a distance (D_{V}) 350a from the other vehicle 220 using the following equation 1.

D_{V}=D_{F}*(L₂/L₁), [Equation 1]

where D_{F} is a focal plane distance 340 which is the distance between the focus 310-1 and the focal plane, L₁ is a first length 320a of the image of the other vehicle 220a created on the focal plane, and L₂ is a length 330a of the other vehicle 220a relative to the focal plane axis.

The focal plane distance (D_{F}) 340 is a known design value of the camera, and the focal plane axis may mean an axis parallel with the focal plane.

Equation 1 is an equation when the lens 310-2 has a refractive index of 1. When the lens 310-2 is a convex or concave lens and has a refractive index other than 1, the distance (D_{V}) 350a from the other vehicle 220 may also be calculated using the following equation 2 obtained by multiplying the right side of Equation 1 by a constant relevant to the refractive index of the lens 310-2.

D_{V}=a*D_{F}*(L₂/L₁), [Equation 2]

where a is a refractive index of the lens 310-2, and means a ratio of an angle of refraction to an angle of incidence at which light is incident on the camera.

Unlike FIG. 3A, since the heading angle of another vehicle 220b differs from the heading angle of a vehicle in FIG. 3B, the calculation unit of the distance calculation apparatus according to the embodiment of the present invention may calculate a second length 330b, as the length of the other vehicle 220b relative to the focal plane axis, which is smaller than the width of the other vehicle 220b.

As seen in FIGS. 3A and 3B, the relationship of the second length (L₂) 330a or 330b, the difference value between the heading angle of the vehicle and the heading angle of the other vehicle 220a or 220b, and the width of the other vehicle 220a or 220b is as in the following equation 3.

L₂=k*W, [Equation 3]

where k is a constant that is inversely proportional to the difference value between the heading angle of the vehicle and the heading angle of the other vehicle 220a or 220b, and W is a width of the other vehicle 220a or 220b. Here, k is defined as “1” when the difference value between the heading angle of the vehicle and the heading angle of the other vehicle 220a is “0”, and k is defined as “0” when the difference value between the heading angle of the vehicle and the heading angle of the other vehicle 220a is an angle of 90 degrees.

The calculation unit of the distance calculation apparatus according to the embodiment of the present invention may calculate the distances 350a and 350b from the respective other vehicles 220a and 220b by applying the second lengths 330a and 330b, which are calculated by Equation 3, to Equation 1.

FIG. 4 is a flowchart illustrating the operation of the distance calculation apparatus according to the embodiment of the present invention.

Referring to FIG. 4, the reception unit of the distance calculation apparatus according to the embodiment of the present invention may communicate with at least one object of another vehicle and infrastructure to receive object information including one or more of length information of the object and state information of the object (S400).

When the reception unit communicates with the other vehicle in step S400, it may receive vehicle information including one or more of the length information (width) of the other vehicle and the state information (heading angle) of the other vehicle from the other vehicle.

On the other hand, when the reception unit communicates with the infrastructure in step S400, it may receive infrastructure information including one or more of the length information (width and/or height) of the infrastructure and the state information (installation angle) of the infrastructure from the infrastructure.

When the process in step S400 is performed, the detection unit may detect a first length, which is the length of the object, on the focal plane of the camera capturing the object (S410).

When the vehicle information is received in step S400, a vehicle image is created on the focal plane, and the detection unit may detect a first length which is the length information (width) of the vehicle image generated in step S410.

On the other hand, when the infrastructure information is received in step S400, an infrastructure image is created on the focal plane, the detection unit may detect a first length which is the length information (width and/or height) of the infrastructure image generated in step S410.

When the process in step S410 is performed, the calculation unit may calculate a second length which is the length of the object relative to the focal plane axis, based on the length information and state information of the object (S420).

When the first length, which is the length information (width) of the vehicle image generated in step S410, is detected, the calculation unit may calculate a second length which is the length (width) of the other vehicle relative to the focal plane axis by applying the length information (width) of the other vehicle and the state information (heading angle) of the other vehicle to Equation 3 in step S420.

On the other hand, when the first length, which is the length information (width and/or height) of the infrastructure image generated in step S410, is detected, the calculation unit may calculate a second length which is the length (width and/or height) of the infrastructure relative to the focal plane axis by applying the length information (width and/or height) of the infrastructure and the state information (installation angle) of the infrastructure to Equation 3 in step S420.

When the process in step S420 is performed, the calculation unit may calculate a distance from the object, based on a focal plane distance, which is the distance between the focus and focal plane of the camera, and the first and second lengths (S430).

When the second distance, which is the length (width) of the other vehicle, is calculated in step S420, the calculation unit may calculate a distance from the other vehicle by applying the focal plane distance, which is the distance between the focus and focal plane of the camera, the first distance, which is the length information (width) of the vehicle image, and the second distance, which is the length (width) of the other vehicle relative to the focal plane axis, to Equation 1 or 2.

On the other hand, when the second distance, which is the length (width and/or height) of the infrastructure, is calculated in step S420, the calculation unit may calculate a distance from the infrastructure by applying the focal plane distance, which is the distance between the focus and focal plane of the camera, the first distance, which is the length information (width and/or height) of the infrastructure image, and the second distance, which is the length (width) of the other vehicle relative to the focal plane axis, to Equation 1 or 2.

The distance from the object, which is performed and calculated in steps S400 to S430 by the distance calculation apparatus according to the embodiment of the present invention, may be more accurate than the distance detected based on the image captured by the typical camera.

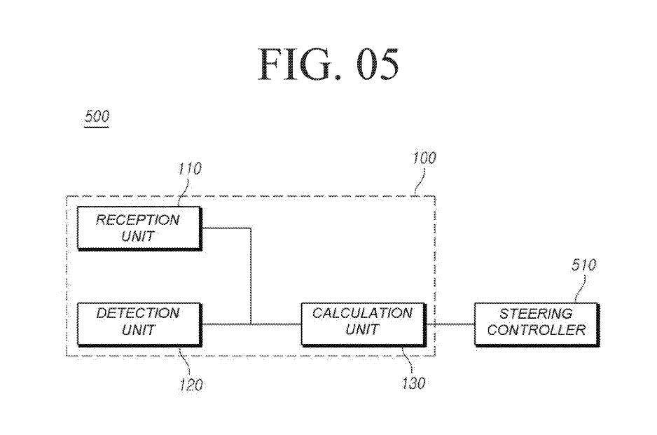

FIG. 5 is a diagram illustrating the configuration of a driving assist apparatus according to an embodiment of the present invention.

Hereinafter, the driving assist apparatus, which is operated based on the distance from the object calculated by the distance calculation apparatus with reference to FIGS. 1 to 4, will be briefly described.

Referring to FIG. 5, the driving assist apparatus, which is designated by reference numeral 500, according to the embodiment of the present invention may include a reception unit 110 which communicates with at least one object of another vehicle and infrastructure to receive object information including one or more of length information of the object and state information of the object, a detection unit 120 which detects a first length, as the length of the object, on the focal plane of a camera capturing the object, a calculation unit 130 which calculates a second length as the length of the object relative to a focal plane axis, based on the length information and state information of the object, and calculates a distance from the object, based on a focal plane distance as the distance between the focus and focal plane of the camera, and the first and second lengths, and a steering controller 510 which controls a steering system, based on the distance from the object.

The steering controller 510 is a unit for controlling the steering system of the vehicle, and may prevent the collision accident between vehicles by controlling the steering system in response to input values.

The steering controller 510 of the driving assist apparatus 500 according to the embodiment of the present invention may control the steering system by comparing the distance from the object, which is calculated by the distance calculation apparatus 100 according to the above embodiment of the present invention, with a predetermined first critical distance, in order to prevent the collision accident between vehicles.

For example, when the distance from the object calculated by the distance calculation apparatus 100 is equal to or less than the predetermined first critical distance, the steering controller 510 may control the steering system to change lanes.

A driving assist apparatus according to another embodiment of the present invention may include one or more of an alarm provision device and a speed controller, instead of the steering controller 510, or may include one or more of an alarm provision device and a speed controller in addition to the steering controller 510.

The alarm provision device may previously inform a driver of the collision accident between vehicles by comparing the distance from the object, which is calculated by the distance calculation apparatus 100 according to the above embodiment of the present invention, with a predetermined second critical distance.

For example, when the distance from the object calculated by the distance calculation apparatus 100 is equal to or less than the predetermined second critical distance, the alarm provision device may inform a driver of an alarm to prevent the collision accident between vehicles in such a manner that the driver recognizes the alarm and operates a steering system or a brake system.

The speed controller may control a vehicle speed by comparing the distance from the object, which is calculated by the distance calculation apparatus 100 according to the above embodiment of the present invention, with a predetermined third critical distance, in order to prevent the collision accident between vehicles.

For example, when the distance from the object calculated by the distance calculation apparatus 100 is equal to or less than the predetermined third critical distance, the speed controller may prevent the collision accident between vehicles by decreasing the vehicle speed.

The first, second, and third critical distances may be calculated in advance through respective experiments.

The steering controller 510, the alarm provision device, and the speed controller may be additionally operated according to a TTC (Time To Collision) which is calculated based on the distance from the object calculated by the distance calculation apparatus 100 according to the above embodiment of the present invention.

For example, the steering controller 510 may control the steering system by comparing the calculated TTC with a predetermined first critical time, in order to prevent the collision accident between vehicles.

That is, when the distance from the object calculated by the distance calculation apparatus 100 is equal to or less than the predetermined first critical distance, and the calculated TTC is equal to or less than the predetermined first critical time, the steering controller 510 may rapidly control the steering system by applying a large amount of current to the steering system.

On the other hand, when the distance from the object calculated by the distance calculation apparatus 100 is equal to or less than the predetermined first critical distance, and the calculated TTC exceeds the predetermined first critical time, the steering controller 510 may slowly control the steering system by applying a small amount of current to the steering system.

The current applied to the steering system according to the above situation may be determined based on a data map calculated through experimental data.

For another example, the alarm provision device may provide an alarm by comparing the calculated TTC with a predetermined second critical time, in order to prevent the collision accident between vehicles.

That is, when the distance from the object calculated by the distance calculation apparatus 100 is equal to or less than the predetermined second critical distance, and the calculated TTC is equal to or less than the predetermined second critical time, the alarm provision device may provide a high-sound alarm by applying a large amount of current to an alarm device.

On the other hand, when the distance from the object calculated by the distance calculation apparatus 100 is equal to or less than the predetermined second critical distance, and the calculated TTC exceeds the predetermined second critical time, the alarm provision device may provide a low-sound alarm by applying a small amount of current to the alarm device.

The current applied to the alarm device according to the above situation may be determined based on a data map calculated through experimental data.

For a further example, the speed controller may control a speed device by comparing the calculated TTC with a predetermined third critical time, in order to prevent the collision accident between vehicles.

That is, when the distance from the object calculated by the distance calculation apparatus 100 is equal to or less than the predetermined third critical distance, and the calculated TTC is equal to or less than the predetermined third critical time, the speed controller may rapidly decelerate the speed device by applying a large amount of current to the speed device.

On the other hand, when the distance from the object calculated by the distance calculation apparatus 100 is equal to or less than the predetermined third critical distance, and the calculated TTC exceeds the predetermined third critical time, the speed controller may slowly decelerate the speed device by applying a small amount of current to the speed device.

The current applied to the speed device according to the above situation may be determined based on a data map calculated through experimental data.

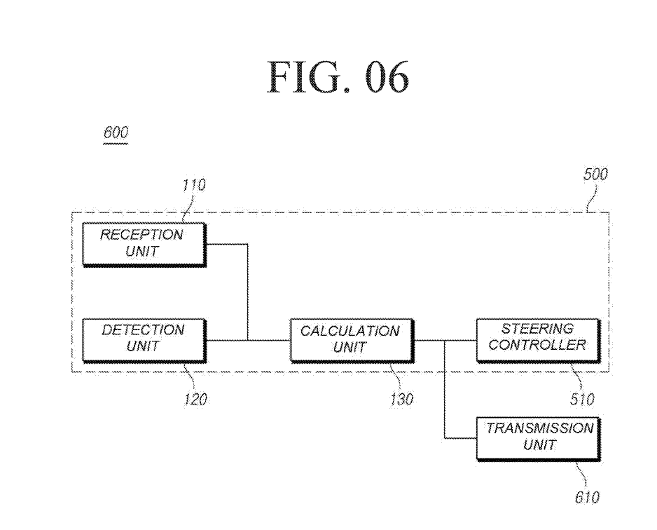

FIG. 6 is a diagram illustrating the configuration of a driving assist apparatus according to another embodiment of the present invention.

Referring to FIG. 6, the driving assist apparatus, which is designated by reference numeral 600, according to another embodiment of the present invention may include a reception unit 110 which communicates with at least one object of another vehicle and infrastructure to receive object information including one or more of length information of the object and state information of the object, a detection unit 120 which detects a first length, as the length of the object, on the focal plane of a camera capturing the object, a calculation unit 130 which calculates a second length as the length of the object relative to a focal plane axis, based on the length information and state information of the object, and calculates a distance from the object, based on a focal plane distance as the distance between the focus and focal plane of the camera, and the first and second lengths, a steering controller 510 which controls a steering system, based on the distance from the object, and a transmission unit 610 which transmits the distance from the object to the other vehicle.

The transmission unit 610 may transmit the distance from the object, which is calculated by the calculation unit 130, to a reception unit mounted in the other vehicle by the communication method used in the reception unit 110. Moreover, when the steering controller 510, the alarm provision device, and the speed controller are additionally operated according to a TTC, the transmission unit 610 may further transmit the TTC to the other vehicle.

As described above, when the transmission unit 610 transmits one or more of the distance from the object and the TTC to the other vehicle, the other vehicle may operate a steering controller, an alarm provision device, and a speed controller, which are mounted therein, based on one or more of the received distance from the object and the received TTC. They may be operated similar to those of the driving assist apparatus described in FIG. 5.

Besides, the driving assist apparatus of the present invention may perform all operations performed by the distance calculation apparatus described with reference to FIGS. 1 to 4.

Hereinafter, a driving assist system, which partially includes the components of the driving assist apparatus described with reference to FIGS. 1 to 6, will be briefly described.

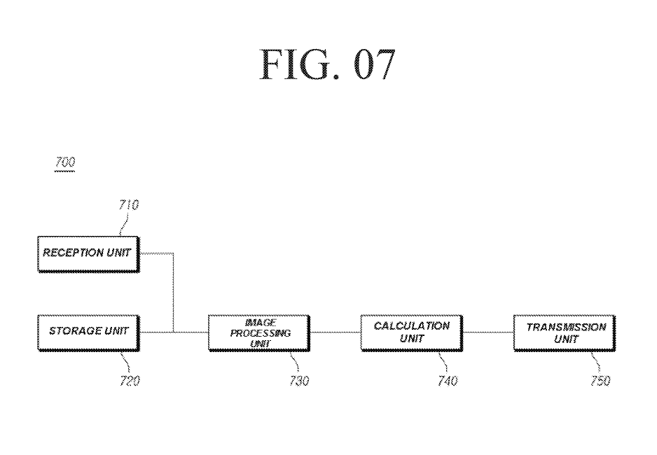

FIG. 7 is a diagram illustrating the configuration of a driving assist system according to an embodiment of the present invention.

Referring to FIG. 7, the driving assist system, which is designated by reference numeral 700, according to the embodiment of the present invention may include a reception unit 710 which communicates with at least one object of another vehicle and infrastructure to receive object information including one or more of length information of the object, state information of the object, and GPS position information of the object by wireless vehicle communication (V2X), an image processing unit 730 which performs one or more of first image processing for sensing only an ROI set based on the GPS position information and second image processing for analyzing the edge of the image of the object captured by a camera to correct the image, so as to detect a first length, as the length of the object, on the focal plane of the camera capturing the object, based on the obtained image, a storage unit 720 which stores one or more, of the object information and a focal plane distance as the distance between the focus and focal plane of the camera, as data, a calculation unit 740 which calculates a second length as the length of the object relative to a focal plane axis, based on the length information and state information of the object, calculates a distance from the object, based on the focal plane distance and the first and second lengths, and calculates a TTC based on the distance from the object, and a transmission unit 750 which transmits one or more of the distance from the object and the TTC to the other vehicle by wireless vehicle communication.

The wireless vehicle communication is an overall autonomous safety driving-related communication technique which is applicable to vehicles on the road and infrastructure, and may include communication between vehicles (V2V), communication between vehicles and road infrastructure (V2I), communication between vehicles and mobile devices (V2N), etc.

That is, the reception unit 710 may be partially operated similar to the reception unit of the distance calculation apparatus according to the above embodiment of the present invention.

The image processing unit 730 may perform the image processing for sensing only the ROI set based on the GPS position information received from the reception unit 710.

By sensing the set ROI, the image processing unit 730 may detect the object in a shorter time. The shorter time may mean a time required to sense a small region is shorter than the time required to sense one region by the same processor.

In addition, the image processing unit 730 may perform the image processing for analyzing the edge of the image captured by the camera to correct the image.

Since the edge extracted from the image includes the critical shape information of the object, it may be based in recognizing and analyzing the image. Thus, the image processing unit 730 may more accurately detect the first length on the focal plane by analyzing the edge and correcting the image.

The image processing unit 730 may partially include the functions of the detection unit of the distance calculation apparatus according to the above embodiment of the present invention.

The storage unit 720 may store one or more, of the object information received in the reception unit 710 and the focal plane distance as the distance between the focus and focal plane of the camera, as data.

Then, the image processing unit 730 may detect the first length using the object information stored in the storage unit 720, and the calculation unit 740 may calculate one or more of the distance from the object and the TTC using the focal plane distance stored in the storage unit 720.

The transmission unit 750 may transmit one or more, of the distance from the object and the TTC calculated by the calculation unit 740, as values, but the present invention is not limited thereto. That is, the transmission unit 750 may also transmit a warning signal based on the distance from the object and the TTC.

Besides, the driving assist system 700 according to the embodiment of the present invention may perform all operations performed by the driving assist apparatus described with reference to FIGS. 1 to 6.

Hereinafter, a distance calculation method, which is performed by the distance calculation apparatus described with reference to FIGS. 1 to 4, will be briefly described.

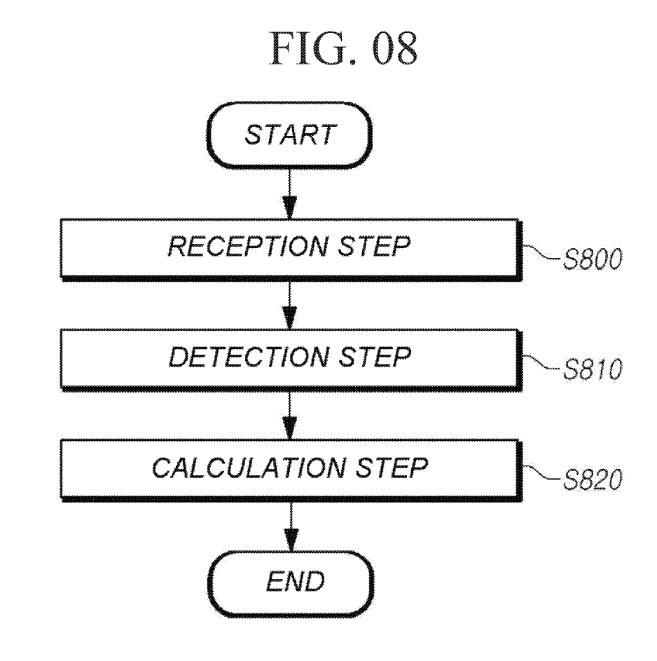

FIG. 8 is a flowchart illustrating a distance calculation method according to an embodiment of the present invention.

Referring to FIG. 8, the distance calculation method according to the embodiment of the present invention may include a reception step (S800) of communicating with at least one object of another vehicle and infrastructure to receive object information including one or more of length information of the object and state information of the object, a detection step (S810) of detecting a first length, as the length of the object, on the focal plane of a camera capturing the object, and a calculation step (S820) of calculating a second length as the length of the object relative to a focal plane axis, based on the length information and state information of the object, and of calculating a distance from the object, based on a focal plane distance as the distance between the focus and focal plane of the camera, and the first and second lengths.

In the reception step (S800), the length information and state information of the object, which are transmitted using various communications such as DSRC (Dedicated Short Range Communication) and ADSRC (Advanced DSRC) as dedicated short-range ITSs (Intelligent Transport Systems), and WiBro (Wireless Broadband Internet), may be received.

In general, each of the DSRC and the ADSRC is a near-field communication technique between road-side equipment and OBE (On-Board Equipment), and the communication may be performed using the OBE. The WiBro is a wireless communication technique which enables massive data to be transmitted/received through internet even in a vehicle traveling at a speed of about 100 km/h, as well as internet telephone, and download and upload may be performed at speeds of respective 240 Mbps and 6 Mbps.

For example, another vehicle may transmit vehicle information about the width and heading angle thereof using the above communication techniques. In the reception step (S800), the vehicle information may be received. The heading angle means a direction of progress of a vehicle. When the heading angle of a vehicle is equal to the heading angle of another vehicle, the camera of the vehicle may detect a width corresponding to the transmitted width of the other vehicle. However, when the heading angle of the vehicle is unequal to the heading angle of the other vehicle, the camera of the vehicle detects a width smaller than the transmitted width of the other vehicle.

For another example, infrastructure (infra) installed near the road may transmit infrastructure information about the width and arrangement angle thereof using the above communication techniques. In the reception step (S800), the infrastructure information may be received. The arrangement angle may mean the arrangement of infrastructure. When the heading angle of a vehicle is equal to the arrangement angle of the infrastructure, the camera of the vehicle may detect a width corresponding to the transmitted width of the infrastructure. However, when the heading angle of the vehicle is unequal to the arrangement angle of the infrastructure, the camera of the vehicle detects a width smaller than the transmitted width of the infrastructure.

In the detection step (S810), the first length, as the length of the object, on the focal plane of the lens of the camera which captures the object, may be detected. For example, when the camera is a CMOS camera, the focal plane may be a CMOS plane.

In the calculation step (S820), a difference value between the heading angle of the vehicle and the heading angle of the other vehicle may be applied to the width of the other vehicle, so as to calculate a second length as the width of the other vehicle relative to the focal plane axis. The focal plane axis may mean an axis parallel with the focal plane.

In addition, a distance from the other vehicle may be calculated using the relationship of the focal plane distance as the distance between the focus and the focal plane of the camera, the detected first length, and the calculated second length, in the calculation step (S820).

For example, when the lens of the camera has a refractive index of 1, the ratio between the focal plane distance and the first length coincides with the ratio between the distance from the other vehicle and the second length. Thus, the distance from the other vehicle may be calculated using the above relationship.

On the other hand, when the lens of the camera has a refractive index other than 1, the product of the refractive index of the lens and the ratio between the focal plane distance and the first length coincides with the ratio between the distance from the other vehicle and the second length. Thus, the distance from the other vehicle may be calculated using the above relationship.

In addition, first lane information detected from another vehicle is further received in the reception step (S810), and the second length may be calculated based on the comparison value of the first lane information with second lane information captured by the camera, in the calculation step (S820).

When errors are included in the heading angle of a vehicle and the heading angle of another vehicle, the second length may be erroneously calculated. To prevent this, the reception unit may further receive the first lane information detected from the other vehicle, and the calculation unit may calculate the second length, based on the comparison value of the first lane information with the second lane information captured by the camera.

For example, when the comparison value of the first lane information with the second lane information is great, the second length may be calculated as a value smaller than the received width. In addition, when the comparison value of the first lane information with the second lane information is “0”, the second length may be calculated as a value equal to the received width.

As described above, the distance from the other vehicle, which is calculated by the distance calculation method, may be a more accurate value than a distance detected based on the image captured by a typical camera.

Besides, the distance calculation method of the present invention may perform all operations performed by the distance calculation apparatus described with reference to FIGS. 1 to 4.

As is apparent from the above description, the present invention can provide an apparatus and method for accurately measuring a distance using only a camera.

In addition, the present invention can provide a driving assist apparatus and system including one or more of an alarm provision device, a speed controller, and a steering controller which are operated based on the distance accurately measured using only a camera.

Although embodiments have been described with reference to a number of illustrative embodiments thereof, it should be understood that numerous other modifications and applications may be devised by those skilled in the art that will fall within the intrinsic aspects of the embodiments. More particularly, various variations and modifications are possible in concrete constituent elements of the embodiments. In addition, it is to be understood that differences relevant to the variations and modifications fall within the spirit and scope of the present disclosure defined in the appended claims.

What is claimed is:

1. A distance calculation apparatus comprising:
a reception unit configured to communicate with at least one object of another vehicle and infrastructure so as to receive object information comprising one or more of length information of the object and state information of the object;
a detection unit configured to detect a first length, as a length of the object, on a focal plane of a camera capturing the object; and
a calculation unit configured to calculate a second length as a length of the object relative to a focal plane axis, based on the length information and state information of the object, and to calculate a distance from the object, based on a focal plane distance, as a distance between a focus and the focal plane of the camera, and the first and second lengths.

2. The distance calculation apparatus according to claim 1, wherein the object information further comprises position information of the object, the position information is a position received through a GPS (Global Positioning System), the length information is a width, and the state information is a heading angle of the other vehicle.

3. The distance calculation apparatus according to claim 2, wherein the detection unit sets an ROI (Region Of Interest) based on the position information, and senses only the ROI to detect the first length, as the length of the object, on the focal plane.

4. The distance calculation apparatus according to claim 2, wherein the calculation unit calculates the second length by applying a difference value between a heading angle of a vehicle and the heading angle of the other vehicle to the width.

5. The distance calculation apparatus according to claim 1, wherein:
the reception unit further receives first lane information, as lane information of the other vehicle, detected from the other vehicle, and the detection unit further detects second lane information, as lane information of a vehicle, using the camera; and
the calculation unit calculates the second length, based on a comparison value of the first lane information with the second lane information.

6. The distance calculation apparatus according to claim 1, wherein the detection unit analyzes an edge of an image captured by the camera to correct the image, and detects the first length on the focal plane based on the corrected image.

7. The distance calculation apparatus according to claim 1, wherein:
the reception unit further receives first lane information detected from the other vehicle; and
the calculation unit calculates the second length, based on a comparison value of the first lane information with second lane information captured by the camera.

8. A driving assist apparatus comprising:
a reception unit configured to communicate with at least one object of another vehicle and infrastructure so as to receive object information comprising one or more of length information of the object and state information of the object;
a detection unit configured to detect a first length, as a length of the object, on a focal plane of a camera capturing the object;
a calculation unit configured to calculate a second length as a length of the object relative to a focal plane axis, based on the length information and state information of the object, and to calculate a distance from the object, based on a focal plane distance, as a distance between a focus and the focal plane of the camera, and the first and second lengths; and
one or more of an alarm provision device to provide an alarm based on the distance from the object, a speed controller to control a speed based on the distance from the object, and a steering controller to control a steering system based on the distance from the object.

9. The driving assist apparatus according to claim 8, wherein the alarm provision device, the speed controller, and the steering controller are additionally operated according to a TTC (Time To Collision) calculated based on the distance from the object.

10. The driving assist apparatus according to claim 9, further comprising a transmission unit configured to transmit one or more of the distance from the object and the TTC to the other vehicle.

11. The driving assist apparatus according to claim 10, wherein the other vehicle is operated based on one or more of the distance from the object and the TTC received from the transmission unit.

12. A driving assist system comprising:
a reception unit configured to communicate with at least one object of another vehicle and infrastructure so as to receive object information comprising one or more of length information of the object, state information of the object, and GPS position information of the object by wireless vehicle communication (V2X);
an image processing unit configured to perform one or more of first image processing for sensing only an ROI set based on the GPS position information and a second image processing for analyzing an edge of an image of the object captured by a camera to correct the image, so as to detect a first length, as a length of the object, on a focal plane of the camera, based on the obtained image;
a storage unit configured to store one or more, of the object information and a focal plane distance as a distance between a focus and the focal plane of the camera, as data;
a calculation unit configured to calculate a second length as a length of the object relative to a focal plane axis, based on the length information and state information of the object, to calculate a distance from the object based on the focal plane distance and the first and second lengths, and to calculate a TTC based on the distance from the object; and
a transmission unit configured to transmit one or more of the distance from the object and the TTC to the other vehicle by wireless vehicle communication.

13. A distance calculation method comprising:
performing a reception process of communicating with at least one object of another vehicle and infrastructure so as to receive object information comprising one or more of length information of the object and state information of the object;
performing a detection process of detecting a first length, as a length of the object, on a focal plane of a camera capturing the object; and
performing a calculation process of calculating a second length as a length of the object relative to a focal plane axis, based on the length information and state information of the object, and of calculating a distance from the object, based on a focal plane distance, as a distance between a focus and the focal plane of the camera, and the first and second lengths.

14. The distance calculation method according to claim 13, wherein, in the performing a calculation process, the second length is calculated by application of a difference value between a heading angle of a vehicle and the heading angle of the other vehicle.

15. The distance calculation method according to claim 13, wherein:
first lane information, as lane information of the other vehicle, detected from the other vehicle is further received in the performing a reception process, and second lane information as lane information of a vehicle is further detected using the camera in the performing a detection process; and
in the performing a calculation process, the second length is calculated based on a comparison value of the first lane information with the second lane information.
